(19) United States
(12) Patent Application Publication
(10) Pub. No.: US 2007/0036630 A1
(43) Pub. Date: Feb. 15, 2007

(54) Penetrating washer

(75) Inventors: Roy Clifton Butzer, Livonia, MI (US); Dane Charles Butzer, New Albany, OH (US)

Correspondence Address: BUTZER & CHEN LAW, LLC, 870 HIGH STREET, SUITE 104, WORTHINGTON, OH, 43085, US

(73) Assignee: 3Bz Ltd, a limited liability company, Worthington, OH (US)

(21) Appl. No.: 11/254,340

(22) Filed: Oct. 20, 2005

Related U.S. Application Data
(60) Provisional application No. 60/707,868, filed on Aug. 12, 2005.

(51) Int. Cl. F16B 39/24

(52) U.S. Cl. 411/160

(57) ABSTRACT

A penetrating washer for use with a carriage bolt. The penetrating washer includes a flat section with a non-circular hole and one or more prongs, ridges, or other protrusions extending from a face of the flat section. A size of the non-circular hole preferably corresponds to a size of a top shaft of the carriage bolt. The non-circular hole can be a polygonal hole with round or sharp corners, for example a square hole with round or sharp corners. Any number of prongs, ridges, or other protrusions can be used, for example four. The non-circular hole preferably is in a center of the flat section. Also, methods of making and using the penetrating carriage bolt washer.

### CROSS REFERENCE TO RELATED APPLICATION

This application claims priority from U.S. Provisional Application No. 60/707,868, entitled “Penetrating Washer,” in the name of the same inventor, filed Aug. 12, 2005.

### BACKGROUND OF THE INVENTION

1. Field of the Invention

This invention relates to a penetrating washer with prongs, ridges, or other protrusions and a non-circular hole, for example a square hole, for use with carriage bolts.

2. Description of the Related Art

Carriage bolts are used for a great variety of fastening and joining applications. These bolts typically have a smooth head, a polygonal (e.g., square) top shaft, and a round threaded bottom shaft.

In some applications, the carriage bolt is inserted into a polygonal-shaped hole that is only slightly larger than the polygonal top shaft. This prevents the carriage bolt from rotating in the hole, thereby facilitating easy attachment of a nut to the threaded bottom shaft of the carriage bolt.

However, carriage bolts also are often used with round holes. This is particularly true when the carriage bolts are used with wood or by people for do-it-yourself and self-assembly projects. Round holes are often used because most people do not have tools available for drilling polygonal bolt holes.

A problem arises when carriage bolts are used with round holes. In particular, the carriage bolt will tend to rotate within the round hole as a nut is being attached to the threaded bottom shaft of the carriage bolt. This rotation can prevent proper tightening of the nut and in any case can be extremely frustrating.

### SUMMARY OF THE INVENTION

One embodiment of the invention that addresses the foregoing problem is a penetrating washer for use with a carriage bolt. The penetrating washer includes a flat section with a non-circular hole and one or more prongs, ridges, or other protrusions extending from a face of the flat section. A size of the non-circular hole corresponds to a size of a top shaft of the carriage bolt.

In a preferred embodiment, the non-circular hole is a polygonal hole with round or sharp corners, for example a square hole with round or sharp corners. Any number of prongs, ridges, or other protrusions can be used, for example four. The non-circular hole preferably is in the center of the flat section.

The penetrating washer can be made by forming the non-circular hole in a blank for the penetrating washer and bending down or stamping portions of the blank, for example corners, to form the prongs, ridges, or other protrusions. In the case that the non-circular hole is polygonal, sides of the blank preferably align with sides of the polygonal hole.

In one way of using the penetrating washer, the carriage bolt can be secured to one or more pieces of material by inserting the carriage bolt through the penetrating washer and through holes in the pieces of material, and then tightening a nut to a threaded bottom shaft of the carriage bolt. In this use, the prongs, ridges, or other protrusions of the penetrating washer will penetrate into the piece of material closest to the head of the carriage bolt as the nut is tightened. The top shaft of the carriage bolt will then be kept from rotating freely when it passes through the non-circular hole in the penetrating washer. Thus, the carriage bolt will be less likely to rotate in the through holes in the pieces of material, making it easier to achieve a secure attachment.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows an embodiment of a penetrating washer for use with a carriage bolt.

FIG. 2 shows some possible variations on the embodiment shown in FIG. 1.

FIG. 3 shows an embodiment of a partially formed blank that can be used to make a penetrating washer for use with a carriage bolt.

FIG. 4 shows use of the penetrating washer when securing the carriage bolt to one or more pieces of material.

### DESCRIPTION OF THE PREFERRED EMBODIMENT

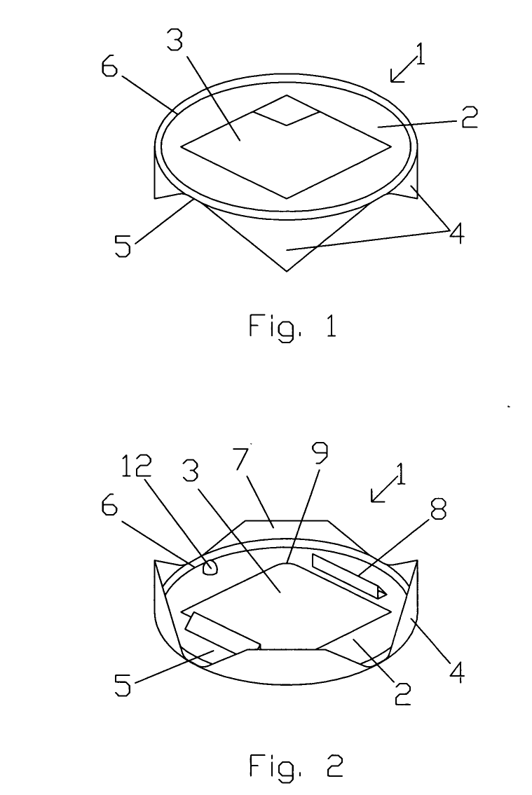

FIG. 1 shows an embodiment of a penetrating washer for use with a carriage bolt. FIG. 2 shows some possible variations on the embodiment shown in FIG. 1.

In the embodiment shown in FIG. 1, penetrating washer 1 includes flat section 2 with non-circular hole 3. In this embodiment, the hole is square shaped, but this need not be the case. The hole can be any non-circular shape as long as the top shaft of an appropriately-sized carriage bolt will not rotate freely within the hole.

In a preferred embodiment, the shape of the non-circular hole will generally match the shape of the top shaft of the carriage bolt. For example, if the top shaft is square, the hole preferably will be square shaped. However, this need not be the case. For example, an oval shaped hole that fits snuggly on a square top shaft of a carriage bolt on two sides will prevent the carriage bolt from rotating freely within the hole and therefore is within the scope of the invention.

Because most carriage bolts have a polygonal shaped top shaft, the hole preferably is polygonal shaped. In this application, “square shaped” is considered to be a subset of “polygonal shaped.” Thus, for square top shafts, the hole preferably is square shaped. Again, this need not be the case. The hole can have any other shape, symmetric or non-symmetric, that prevents free rotation of the top shaft of an appropriately-sized carriage bolt. Examples of possible shapes include, but are not limited to, oval, polygonal (e.g., triangular, square, pentagonal, hexagonal, heptagonal, octagonal, or any other polygonal shape) with square or rounded corners, etc. Corner 9 in FIG. 2 illustrates a rounded corner. As stated above, any other non-circular shape can be used for hole 3.

According to the invention, a size of non-circular hole 3 corresponds to a size of a top shaft of a carriage bolt with which the penetrating washer is designed to be used. In this context, the term “corresponding” means that a top shaft of the carriage bolt will pass through the hole but will not be able to rotate freely within the hole. The hole preferably will fit snugly about the top shaft, but this need not be the case. For example, if the top shaft has a square shape 0.25″ on a side and the hole is square shaped, the hole can be 0.26″ or even 0.30″ or so on a side. Tighter and looser fits are usable.

Thus, a shape and size of the non-circular hole are only constrained by a shape and size of a top shaft of a carriage bolt with which the penetrating washer is designed to be used. The sole criterion is that the carriage bolt will not rotate freely within the hole.

Penetrating washer 1 in FIG. 1 also includes one or more prongs 4 extending from face 5 of flat section 2. FIG. 2 also shows that ridges 7 can be used instead of or in addition to prongs 4. Likewise, ridges 8 or other protrusions 12 can be used. According to the invention, any combination of prongs, ridges, and/or other protrusions can be used as long as the prongs, ridges and/or other protrusions tend to hold penetrating washer 1 in place when the washer is pressed against a piece of suitable material.

In FIGS. 1 and 2, the prongs, ridges, or other protrusions are shown as extending at substantially a ninety degree angle from face 5 of flat section 2. While this is preferable, this also need not be the case; the prongs, ridges, or other protrusions can extend at a sharper or shallower angle.

Four prongs, ridges, or other protrusions 4 are shown for penetrating washer 1 in FIG. 1, but this need not be the case. The number of prongs, ridges, or other protrusions 4 preferably matches a number of sides of non-circular hole 3. However, in other embodiments, any number of prongs, ridges, or other protrusions can be used.

Non-circular hole 3 preferably is in a center of flat section 2. Again, this need not be the case; the hole can be off-center for some applications.

Curved line 6 in FIGS. 1 and 2 illustrates that the flat section can curve on its outer edge, for example as a result of a manufacturing process for the penetrating washer. Splits, lock ridges (i.e., for locking to a head of a carriage bolt), or any other structures also can be included in the penetrating washer.

In a preferred embodiment, the penetrating washer is made of steel, stainless steel, or some other metal. Alternatively, the penetrating washer can be made from any other suitably strong and durable material including but not limited to plastic, resin, etc. The material (including metals) can be coated, for example to be rust resistant, or uncoated.

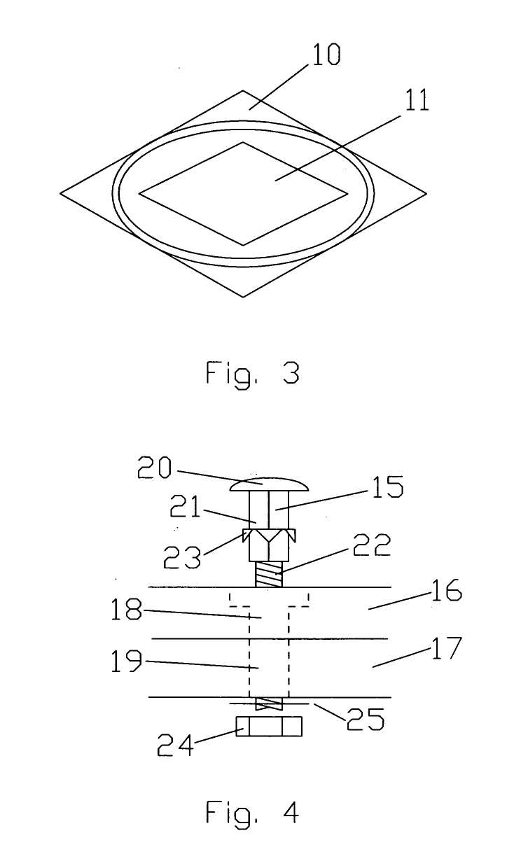

FIG. 3 shows an embodiment of a partially formed blank that can be used to make a penetrating washer for use with a carriage bolt. This blank 10 is a flat piece of material with non-circular hole 11. Square blanks are preferable because they can be cut from metal coils (i.e., rolled metal) without waste during manufacturing. However, any shaped blank cut or formed from any suitable material can be used. Likewise, in FIG. 3, hole 11 is square shaped, but this need not be the case. The hole can be any non-circular shape as discussed above.

One method of making the penetrating washer is to form a non-circular hole in a blank, for example by punching or cutting the hole into the blank. This would result in a partially formed blank such as shown in FIG. 3. Then, the corners of the blank can be bent down to form prongs, ridges, or other protrusions for the penetrating washer. Alternatively, ridges or other protrusions can be stamped into the blank. In a preferred embodiment, all corners are bent down, but again this need not be the case.

Curved lines in FIG. 3 indicate where bends can be made to form the prongs, ridges, or other protrusions, for example by a press or die. The bends need not be sharp. For example, the bends can extend over both curved lines.

In a preferred embodiment, sides of non-circular hole 11 align with sides of the blank. This results in a stronger penetrating washer. However, the sides of the non-circular hole do not need to align with the sides of the blank.

A penetrating washer for use with a carriage bolt can be made in other ways without departing from the invention.

FIG. 4 shows use of a penetrating washer when securing a carriage bolt to one or more pieces of material. In this figure, carriage bolt 15 is secured to pieces of material 16 and 17 that have holes 18 and 19. The bolt includes head 20, which can be smooth or grooved (for example for a screw driver), polygonal top shaft 21, and threaded bottom shaft 22.

Carriage bolt 15 in FIG. 4 is inserted through penetrating washer 23 such as shown in FIG. 1 and through holes 18 and 19. Prongs, ridges, or other protrusions of penetrating washer 23 extend from a face of the penetrating washer opposite head 20 of the carriage bolt. Nut 24 is tightened onto threaded bottom shaft 22 of the carriage bolt, possibly along with regular washer 25.

In this use, the prongs, ridges, or other protrusions of the penetrating washer will penetrate into or press against the piece of material closest to a head of the carriage bolt as the nut is tightened. The top shaft of the carriage bolt will then be restrained from rotating when it passes through the non-circular hole. Thus, the carriage bolt will be less likely to rotate in the through holes in the pieces of material, making it easier to achieve a secure attachment. In addition, if the nut needs to be loosened, the penetrating washer will help to keep the bolt from rotating. This can greatly help with loosening even very tight nuts.

The penetrating washer can be used in other ways as well.

### Alternative Embodiments

The invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A penetrating washer for use with a carriage bolt, comprising:
a flat section with a non-circular hole; and
one or more prongs, ridges, or other protrusions extending from a face of the flat section.

2. A penetrating washer as in claim 1, wherein the prongs, ridges, or other protrusions are prongs.

3. A penetrating washer as in claim 1, wherein the prongs, ridges, or other protrusions are ridges.

4. A penetrating washer as in claim 1, wherein the prongs, ridges, or other protrusions are other protrusions.

5. A penetrating washer as in claim 1, wherein a size of the non-circular hole corresponds to a size of a top shaft of the carriage bolt.

6. A penetrating washer as in claim 5, wherein the non-circular hole is a polygonal hole with round or sharp corners.

7. A penetrating washer as in claim 6, wherein the polygonal hole is a square hole with round or sharp corners.

8. A penetrating washer as in claim 7, wherein a number of the prongs, ridges, or other protrusions is four.

9. A penetrating washer as in claim 1, wherein the non-circular hole is in a center of the flat section.

10. A penetrating washer as in claim 1, wherein the flat section and the prongs, ridges, or other protrusions are formed from a blank with the non-circular hole, and the prongs, ridges, or other protrusions are formed by bending down or stamping portions of the blank.

11. A penetrating washer as in claim 1, wherein the penetrating washer is made of steel, stainless steel, or some other metal.

12. A method of making a penetrating washer for use with a carriage bolt, the penetrating washer including a flat section with a non-circular hole and one or more prongs, ridges, or other protrusions extending from a face of the flat section, comprising the steps of:
forming the non-circular hole in a blank for the penetrating washer; and
bending down or stamping portions of the blank to form the prongs, ridges, or other protrusions.

13. A method as in claim 12, wherein a size of the non-circular hole corresponds to a size of a top shaft of the carriage bolt.

14. A method as in claim 13, wherein the non-circular hole is a polygonal hole with round or sharp corners.

15. A method as in claim 14, wherein the polygonal hole is a square hole with round or sharp corners.

16. A method as in claim 12, wherein the non-circular hole is formed in a center of the flat section.

17. A method of securing a carriage bolt to one or more pieces of material, comprising the steps of:
inserting the carriage bolt through a penetrating washer and through holes in the pieces of material, the penetrating washer including a flat section with a non-circular hole and one or more prongs, ridges, or other protrusions extending from a face of the penetrating washer opposite a head of the carriage bolt; and
tightening a nut to a threaded bottom shaft of the carriage bolt.

18. A method as in claim 17, wherein a size of the non-circular hole corresponds to a size of a top shaft of the carriage bolt.

19. A method as in claim 18, wherein the non-circular hole is a polygonal hole with round or sharp corners.

20. A method as in claim 19, wherein the polygonal hole is a square hole with round or sharp corners.
